(19) United States
(12) Patent Application Publication
(10) Pub. No.: US 2014/0227106 A1
(43) Pub. Date: Aug. 14, 2014

(54) Natural Gas Pressure Regulator That Produces Electric Energy

(71) Applicants: Kenneth A. Jackson, Glenmont, OH (US); William A. Schureck, Lexington, OH (US)

(72) Inventors: Kenneth A. Jackson, Glenmont, OH (US); William A. Schureck, Lexington, OH (US)

(21) Appl. No.: 14/232,534

(22) PCT Filed: Jul. 12, 2012
(86) PCT No.: PCT/US12/46525

§ 371 Date: Apr. 21, 2014

Related U.S. Application Data
(60) Provisional application No. 61/507,924, filed on Jul. 14, 2011.

(51) Int. Cl. F04D 15/00; H02P 9/00; H02K 7/18

(52) U.S. Cl. CPC F04D 15/0066; H02K 7/1823; H02P 9/008; H02P 2009/001
USPC 417/44.2; 290/52

(57) ABSTRACT

The invention is a method to regulate gas pressure by controlling the expansion of a gas through an air motor that is attached to an electric generator. There are four components. The first is a sensor that measures the pressure of the gas coming into the air motor. The second is an air motor that changes the pressure of the gas into mechanical energy. The third is a generator that takes the mechanical energy from the air motor and changes it into the electrical energy. The forth is a control unite. The control unit reads the pressure of the gas from the sensor and varies the electric load on the generator. The varying of the electrical load on the generator varies the torque on the air motor which changes the pressure of the gas passing through the air motor.

### FIELD OF THE INVENTION

This invention relates to the field of regulation of gas pressure and more particularly to the field of regulation of gas pressure through the production of useable energy from the pressure of the gas.

### BACKGROUND OF THE INVENTION

Gas under pressure is a source of energy that can be taped without destroying the caloric value of the gas. The pressure of the gas out of the well varies over a wide range. However, the gas pressure come up from the well on average is well above the pressure need for the line. All this pressure above the line pressure can be changed into mechanical/electrical energy. An objective of the invention is to turn the pressure of the gas that comes from the well into useable energy without destroying the caloric value of the gas.

One of the problems for gas producers is that a gas well does not produce gas at constant pressure. This is especially a problem when one is trying to produce power from the gas pressure. The gas varies at such a wide range that at times the gas rise to a pressure where it almost needs to be vented or it can drop to a pressure that liquefies the gas and freezes the gas regulator system. Therefore, these systems may have a net energy loss in that they need an external heating system to prevent freezing. Thus, one of the objectives of this invention is to create an inexpensive device that will even out the gas pressure from the well to one low pressure.

Applicant device is able to even out the pressure of the gas from the well and at the same time produce a useable energy gain. The device also lessens the output of green house gases at the wellhead.

In oil wells gas comes up with the oil. This gas needs to be vented off to allow the oil to flow out of the well. Many picture especially of older well one sees the oil well with a flame. The flame is the gas vented from the well. This is a waste of energy and increases the oil well's carbon footprint. The major problem with recovering the gas from the well is the varying pressure the gas comes from the well. Thus, an objective of this invention is to capture the gas from the oil well and used the pressure of the gas to produce useable energy and to even out the gas pressure so that the gas can be recovered economically.

The means for achieving the objectives of leveling out the gas pressure from the well and the means for capturing the energy within the gas pressure is an air motor attached to a generator. The gas from the well is expanded through the air motor and the air motor drives a generator. The device measures the pressure of the gas flowing from the well and varies the electrical output of the generator to ensure that the gas that is exiting the air motor is at a constant pressure. The electrical output from the generator can be placed back into the electrical grid or can be used to drive other electrical needs at the wellhead.

### SUMMARY OF THE INVENTION

The invention is a method to regulate gas pressure by controlling the expansion or compression of a gas through an air motor that is attached to an electric motor/generator. The pressure of the gas is measured. With this measurement the load of the motor/generator is modified to ensure that the pressure of the gas exits the air motor at a constant pressure. A device that performs this method consists of four components. The first is a measuring mechanism that measures the pressure of the gas coming into the device. The second is an air motor that changes the pressure of the gas into mechanical energy. The third is a generator that takes the mechanical energy from the air motor and changes it into the electrical energy. Thus the generator can be used to change the pressure of the gas passing through the air motor by varying the electrical load on the generator which will vary the torque on the air motor. By varying the torque on the air motor one can control the output pressure of the air motor. The measuring mechanism measures the incoming gas pressure and communicates that to the forth component, the generator's control. The generator's control takes the information of the pressure of the incoming gas from the measuring device and varies the electrical load on the generator. By applying the proper electrical load to the generator, the generator will cause the torque of the air motor to reduce or raise the pressure of the gas to the designate pressure for the output line.

### BRIEF DESCRIPTION OF THE DRAWINGS

FIG. 1 is a front view of the invention

FIG. 2 is a back view of the invention

FIG. 3 is a cut away view of the air motor.

FIG. 4 is a cut away view of the air motor with the impellers bent.

### DETAILED DESCRIPTION OF THE PREFERRED EMBODIMENT

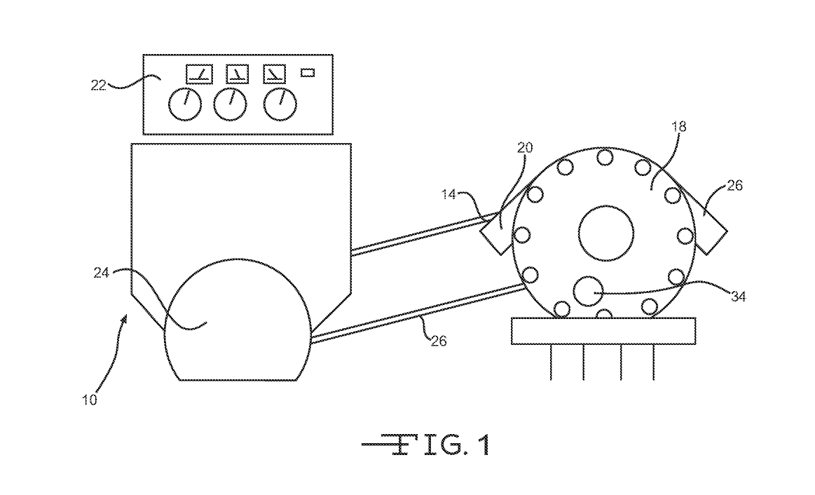

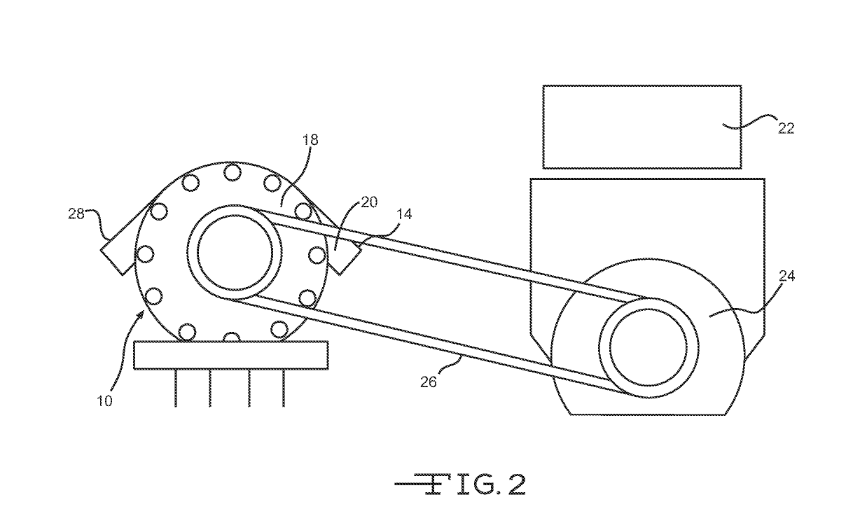

FIG. 1 is a front view of the invention 10. FIG. 2 is the back view of the invention 10. A gas line from a gas or oil well is attached to input port 14 of the air motor 18. Gas from the gas or oil well then flows into air motor 18. Just before the gas gets to the air motor 18 a sensor 20 reads the gas pressure. The sensor 20 sends the information as to the gas pressure to the control unit 22. Within the air motor 18 the gas expands producing mechanical energy. The mechanical energy produced by the air motor 18 is transferred to the motor generator 24 through a belt system 26. The belt system 26 drives the motor generator producing electrical energy. The electrical energy from the motor generator 24 drives an external load. The gas then exits the air motor through gas line 28.

The key to the invention is the control unit 22. The control unit 22 receives the information as to the gas pressure measured by sensor 20. The control unit 22 varies the electrical load on the generator 24 according to the pressure measured by sensor 20. Since the air motor 18 is attached to the generator 24 through a belt system 26 the varying of the electrical load on the generator 24 will vary torque on the air motor 18. By varying the torque on the air motor 18 one can control the pressure of the gas exiting the air motor 18.

The gas comes from a gas or oil well in varying pressures. Those pressures are measured by the sensor 20 just before the air motor 18. The sensor 20 sends the information to the control unit 22 and the control unit 22 varies the load on the generator 24 according to the pressure it received from the sensor 20. The varying load causes the air motor 18 to work at a varying torques. By varying the torque on the air motor 18, one can control the pressure at which the gas exits from the air motor 18. If the gas pressure is too low the motor generator 24 turns the air motor 18 to raise the pressure. If the gas pressure is too high the air motor 18 turns the motor generator 24 to produce electric power that is transferred to an external load.

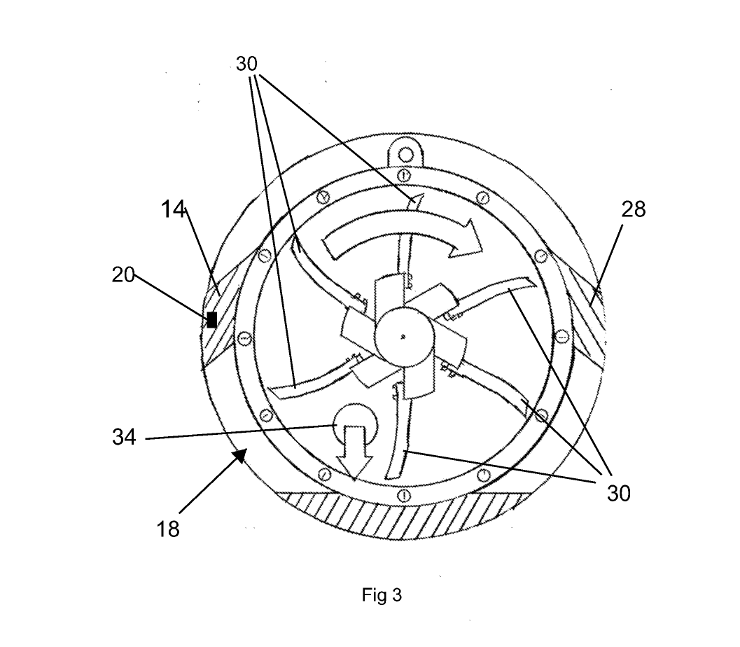

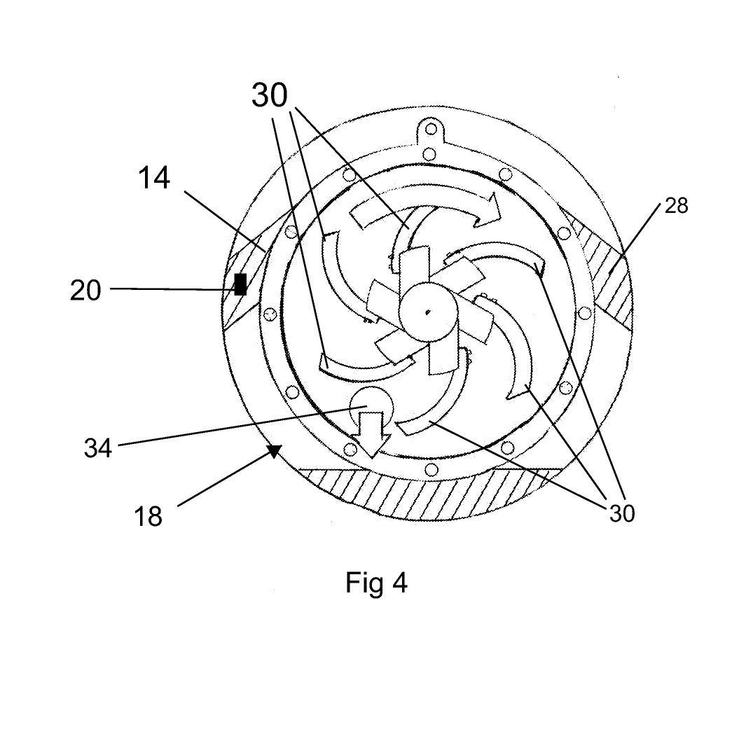

FIGS. 3 and 4 show the inter working of the air motor 18. There are times when the pressure will surge quickly. To compensate for the surges in pressure the impellors 30 within the air motor 18 are flexible. In the preferred embodiment these impellers 30 are made of spring steel to allow the impeller 30 to “collapse”(bend) under high and/or uneven pressure. FIG. 3 shows the air motor with the impellers 30 in normal position. In that position the gas enters the air motor 18 through the port 14. The gas pressure set in motions the impellers 30. The gas pressure pushes the impellers 30 and the gas exits through port 28. When the gas surges the bending of the impeller 30, as shown in FIG. 4, maintain the flow of the gas and allow surges to go around the bent impeller 30. The collapsing or bending impeller 30 also stores energy which is released when the impellers 30 return to their original form once the pressure evens out or drops. This helps to maintain an even torque on the air motor 18 that turns the generator 24. In addition, the impellers 30 are designed remove the liquid in the gas by centrifugal force (to “spin” any addition liquid out of the gas) and exhaust the liquid through drain 34.

Additionally the heat from the operation of the generator 24 is exhausted over the air motor 18. This ensures that the air motor will not freeze if the pressure of the gas drops quickly.

1. A system for regulating the pressure of gas in a line to a desired value comprising:
a. a motor that turn gas pressure into mechanical energy with an entrance for the gas and a output for the gas; and,
b. a motor generator attach to the motor by a drive train that turn the mechanical energy of the motor into electrical energy; and,
c. a sensor that measures the pressure of gas entering the motor; and,
d. a control unite; and,
e. the sensor sends to the control unite the measurement of pressure of the gas; and,
f. the control unit varies the electrical load on the motor generator; and,
g. the control unit is program with the value of the desired pressure of the gas that is outputted by the motor; and,
h. the varying of the electrical load on the motor generator varies the torque of the motor which varies the pressure of the gas that is outputted by the motor; and,
i. the sensor measures the pressure of the gas before it enters the motor and transmits this information to the control unit and the control unit calculates the electrical load necessary to create the torque of the motor that will ensure that the gas will exit the motor at the desired value.

2. A system for regulating the pressure of gas in a line to a desired value as in claim 1 further comprising:
a. when the gas pressure in the line is above the desired value the motor generator produces electric power; and,
b. the electric power is distributed to an external load.

3. (canceled)

4. (canceled)

5. A system for regulating the pressure of gas in a line to a desired value as in claim 2 wherein:
a. The gas in the gas line comes from an oil well.

6. A system for regulating the pressure of gas in a line to a desired value as in claim 2 wherein:
a. The gas in the gas line comes from an gas well.

7. (canceled)

8. A system for regulating the pressure of gas in a line to a desired value as in claim 2 wherein:
a. the drive train is a belt drive system.

9. A system for producing electric energy from a gas or oil well without destroying the caloric value of the gas or oil comprising;
a. a motor that turns gas pressure into mechanical energy; and,
b. a line that caries gas from the well to the motor: and,
c. a motor generator attach to the motor by a drive train that turn the mechanical energy of the motor into electrical energy; and,
d. the electrical energy is distributed to a external load.

10. A system for producing electric energy from a gas or oil well without destroying the caloric value of the gas or oil as in claim 9 further comprising;
a. the system is designed to output the gas at a desired gas pressure; and,
b. the motor has an entrance for the gas and an output for the gas; and,
c. a sensor that measures the pressure the gas as it enters the motor; and,
d. a control unit; and,
e. the control unit varies electric load on the motor generators; and,
f. the control unit is program with the value of the desired pressure of the gas that is outputted by the motor; and,
g. the varying of the electrical load on the motor generator varies the torque of the motor which varies the pressure of the gas that is outputted by the motor; and,
h. the sensor measures the pressure of the gas before it enters the motor and transmits this information to the control unit and the control unit calculates the electrical load necessary to create the torque of the motor that will ensure that the gas will exit the motor at the desired value.

11. A system for regulating the pressure of gas in a line to a desired value as in claim 1 further comprising:
a. impellers within the air motor; and,
b. the impellers are flexible; and,
c. when the gas surges in pressure the impellers bend allow the gas to flow around the impellers.

12. A system for regulating the pressure of gas in a line to a desired value as in claim 11 wherein:
a. the impellers when bent store energy and when they return to normal position release the energy back into the gas pressure.

13. A system for regulating the pressure of gas in a line to a desired value as in claim 11 wherein:
a. centrifugal force acting on the flow of the gas through the air motor separates liquid in the gas from the gas; and,
b. a drain for removing the liquid.

14. A system for regulating the pressure of gas in a line to a desired value as in claim 2 further comprising:
a. impellers within the air motor; and,
b. the impellers are flexible; and,
c. when the gas surges in pressure the impellers bend allow the gas to flow around the impellers.

15. A system for regulating the pressure of gas in a line to a desired value as in claim 14 wherein:
a. the impellers when bent store energy and when they return to normal position release the energy back into the gas pressure.

16. A system for regulating the pressure of gas in a line to a desired value as in claim 14 wherein:
a. centrifugal force acting on the flow of the gas through the air motor separates liquid in the gas from the gas; and,
b. a drain for removing the liquid.

17. A system for producing electric energy from a gas or oil well without destroying the caloric value of the gas as in claim 9 further comprising:
a. impellers within the air motor; and,
b. the impellers are flexible; and,
c. when the gas surges in pressure the impellers bend allow the gas to flow around the impellers.

18. A system for producing electric energy from a gas or oil well without destroying the caloric value of the gas as in claim 17 further comprising;
a. the impellers when bent store energy and when they return to normal position release the energy back into the gas pressure.

19. A system for regulating the pressure of gas in a line to a desired value as in claim 17 wherein:
a. centrifugal force acting on the flow of the gas through the air motor separates liquid in the gas from the gas; and,
b. a drain for removing the liquid.

20. A system for producing electric energy from a gas or oil well without destroying the caloric value of the gas as in claim 10 further comprising:
a. impellers within the air motor; and,
b. the impellers are flexible; and,
c. when the gas surges in pressure the impellers bend allow the gas to flow around the impellers.

21. A system for producing electric energy from a gas or oil well without destroying the caloric value of the gas as in claim 20 further comprising;
a. the impellers when bent store energy and when they return to normal position release the energy back into the gas pressure.

22. A system for regulating the pressure of gas in a line to a desired value as in claim 20 wherein:
a. centrifugal force acting on the flow of the gas through the air motor separates liquid in the gas from the gas; and,
b. a drain for removing the liquid.

23. (canceled)

24. A system for producing electric energy from a gas or oil well without destroying the caloric value of the gas as in claim 10 further comprising:
a. the drive train is a belt drive system.
